(19) United States
(12) Patent Application Publication
(10) Pub. No.: US 2026/0312871 A1
(43) Pub. Date: Oct. 8, 2026

(54) METHOD FOR CONFIGURING NETWORK DEVICES WITHOUT IP REACHABILITY

(71) Applicant: HIRSCHMANN AUTOMATION AND CONTROL GMBH, Neckartenzlingen (DE)

(72) Inventors: Andreas WALDEN, Pliezhausen (DE); Markus SEEHOFER, Rechberghausen (DE)

(73) Assignee: HIRSCHMANN AUTOMATION AND CONTROL GMBH, Neckartenzlingen (DE)

(21) Appl. No.: 19/484,770

(22) PCT Filed: May 13, 2024
(86) PCT No.: PCT/EP2024/063125

§ 371 Date: Nov. 14, 2025

(30) Foreign Application Priority Data
May 15, 2023 (DE) 10 2023 112 805.1

(51) Int. Cl. H04L 41/0866; H04L 41/0813

(52) U.S. Cl. CPC H04L 41/0866; H04L 41/0813

(57) ABSTRACT

In a method for operating a network, wherein at least two network devices are connected to one another in the network via a data line and exchange data via this data line, each network device is permanently associated with an independent MAC address; a network management station controls the configuration and/or the operation of the network; and a query is sent to the network devices from the network management station by multicast by means of a language-independent data format in order to query the configuration parameters of the network devices and/or configure the queried network devices by means of the language-independent data formats.

The invention relates to a method for operating a network, wherein at least two network devices are connected to one another in the network via a data line and exchange data via this data line, wherein each network device is permanently associated with an independent MAC address, wherein furthermore a network management station controls the configuration and/or operation of the network, in accordance with the features of the preamble of claim 1.

Networks in which two or usually more than two network devices (also referred to as network infrastructure devices) are arranged in a ring or line topology and exchange data with each other are generally known. The data exchange takes place via data lines that connect the network devices to each other. These data lines may be cables, but may also be wireless connections, such as radio links.

In practice, the problem is that either a new network, which has been set up from multiple network devices, has to be configured, or the entire configuration of an existing network or part thereof (e.g., when replacing a network device) has to be changed or updated. This is done by means of a network management station that is connected to all network devices in a suitable manner. The network management station can query the respective MAC address of the network devices via the data lines or receive it from the network devices. This means that the network management station initially recognizes that network devices are present in the network, but their configuration has either not yet been performed, is incomplete, or is incorrect.

A method for operating a network is already known from DE 10 2018 111 065 A1, wherein at least two network devices are connected to one another in the network via a data line and exchange data via this data line, wherein a unique MAC address is permanently assigned to each network device, wherein a network management station controls the configuration and/or operation of the network and a query is sent from the network management station to the network devices via multicast using the SNMP protocol in order to query the configuration parameters of the network devices and/or to configure the queried network devices via SNMP. This method has generally proven itself in practice.

US 2019/0 319 836 A1 describes a method for obtaining a configuration file with filter rules for process bus network switches for intelligent electronic devices (“IED”) from a substation specification according to IEC 61850 standard, consisting of the following steps:
From a substation topology file, a control function library file, and a substation bay library file, a substation specification description file and substation traffic demand flow files are calculated, which include a GOOSE message profile subscription file and a sampled value message profile subscription file;
target MAC addresses are generated;
the process bus communication network is simulated using the substation traffic demand files and the topology of the process bus communication network, wherein the topology includes the process bus network switches, corresponding connections, and IED connections;
the shortest path between each Publisher IED and each Subscriber IED is calculated; and
a switch multicast filter rule file is calculated for each switch output port that includes a multicast MAC address filter rule that enables the calculated shortest paths.

The communication between the network devices and/or with the network management station using a language-independent data format is not addressed in this document. In addition, this prior art uses the method described there to generate target MAC addresses and simulate the operation of a network. A language-independent data format is not mentioned.

The invention is based on the objective of improving the known method for operating a network with regard to the commissioning and/or operation of the network. In particular, all network devices present in a network should be detected. In this respect, network devices that have not yet been configured (i.e. new network devices before they are commissioned or after a defective network device has been replaced) or network devices that may be configured incorrectly should be detected and addressed. Furthermore, user-friendliness in practice is to be improved.

The object is achieved by the features of claim 1.

According to the invention, it is provided that a query is sent by the network management station via multicast by means of a language-independent data exchange format to the network devices (to a predetermined network device or to predetermined network devices or to one or more groups of network devices) in order to query the configuration parameters of the network devices and/or to configure the queried network devices by means of the language-independent data exchange format. In this context, “language-independent” means that the data exchange format does not have to be based on a specific data modeling language or a specific programming language.

According to the invention, the data exchange format is used to transfer data between a network management station and at least one network device and a web application. It is a text-based, human-readable format for representing simple data structures and associative arrays (referred to as “objects”). It is (programming) language-independent, easy to understand, and is used for the structured storage of data. This means that the initial configuration of a network device and the subsequent replacement of a defective network device with a new network device and its configuration can be carried out very quickly, easily and in an intuitive manner.

In a further embodiment of the invention, JSON is used as a language-independent data format.

JSON (an abbreviation for “JavaScript Object Notation”) is a well-known compact data format in an easy-to-read text form for data exchange between applications, which is independent of programming languages. Parsers and generators exist in all commonly used programming languages. JSON uses a parser, which is a computer program (software) that breaks down and converts an input into a format that is more suitable for further processing.

JSON is therefore a simple data exchange format used to transfer configuration data between a network management station and at least one network device, usually a plurality of network devices. It is a possible text-based, human-readable format for representing simple data structures. JSON is easy to understand and is used for the structured storage of data. It is also used to exchange data between different programming languages. JSON is a completely independent data format that is not bound to JavaScript or any other programming language. In practical use, it also offers the advantage that (configuration) data can not only be transferred, but can also be displayed, where required or desired.

The respective queried network device is thus brought into the transmitted configuration using JSON. In addition, a queried network device can send its configuration parameters back to the network management station via unicast using JSON.

The method utilizes the knowledge that JSON can also be used to monitor and control network devices (such as computers, printers, routers, servers, switches, and the like) from a central network management station instead of SNMP (Simple Network Management Protocol). The required JSON parsers are installed on the network devices for this purpose. This data exchange format then regulates the communication between the monitored network devices and the network management station. This communication includes, in particular, the initial configuration (reconfiguration) of a network device and/or the procurement of data from this network device, as well as the exchange of information with the network management station. JSON is now well established and can be used to exchange data, in particular configuration data, between the network management station and the respective network device. In this context, the commands “get-request” for requesting a management data set (“discovery” or “read”) and “set-request” for the configuration are used to modify one or more data sets of a network device. When the network management station queries a network device, this is done by means of the command “request”, wherein the network device responds to the query with the command “response”. Based on this, the invention further utilizes the insight that not only is the requesting of management data records by means of the “get-request” command carried out as multicast, but also that the response of the queried device is carried out as unicast via the “get-response” command. Multicast in the network is a message in which data packets are transmitted from one point (the network management station) not to all, but only to predetermined network devices. The invention advantageously makes use of the realization that the multicast packet does not reach all network devices in the network, so that only certain network devices are addressed, in particular those that are to be newly configured or reconfigured.

In a further embodiment of the invention, it is provided that both the query from the network management station and the response from the queried network device are carried out at Layer 3 level. This has the advantage that even a network device that has not yet been configured can be queried based on its known MAC address, since it has not yet been assigned an IP address.

In a further embodiment of the invention, the actual configuration parameters of the queried network device are nevertheless returned, even if the configuration parameters sent by the network management station to the network device do not match the actual configuration parameters of the queried network device. This is done by taking into account the MAC address of the queried network device, so that the network management station queries multiple, preferably all, network devices in the network, and the queried network devices still respond in order to transmit their configuration data to the network management station. Thus, the network management station queries a respective network device using the JSON data exchange format via multicast, whereupon the queried network device responds via unicast and also transmits its configuration parameters back to the network management station using JSON.

In a further embodiment of the invention, it is provided that if the actual configuration parameters of the network device do not match the target configuration parameters required for the intended operation of this network device, the target configuration parameters are transmitted to this network device by means of a further query from the network management station, which are then adopted by the queried network device. This allows a network device that has no configuration parameters stored or has incorrect configuration parameters stored in its memory to be newly and correctly configured, particularly during initial commissioning. The same applies to the replacement of a defective network device, which can thereby be configured quickly and easily. This enables the network management station to transmit the target configuration parameters required for the intended operation of this network device to this network device, so that it can store them and thus commence operation.

In a further embodiment of the invention, the correct adoption of the target configuration parameters by the queried network device is reported back to the network management station. This informs the network management station that the modified or new configuration of the queried network device has been carried out successfully.

In a further embodiment of the invention, the method is performed for non-configured and/or incorrectly configured network devices. The invention thus offers an uncomplicated and quick method for putting a network into operation for the first time or for replacing and configuring network devices in a network that is already in operation.

In a further embodiment of the invention, the configuration parameters of the queried network device are returned independently of the IP address set for this network device at that time. The network management station can thus use the method according to the invention to permanently or temporarily assign an IP address to the respective queried network device, which is then returned to the network management station as set or confirmed via unicast using JSON.

In a further embodiment of the invention, it is provided that the network device is addressed by means of a Universally Unique Identifier (UUID) within the JSON packet. If these (i.e. the transmitted UUID and the UUID stored in the network device) do not match, the configuration parameters are discarded, i.e. not adopted.

The method according to the invention is illustrated with reference to three figures.

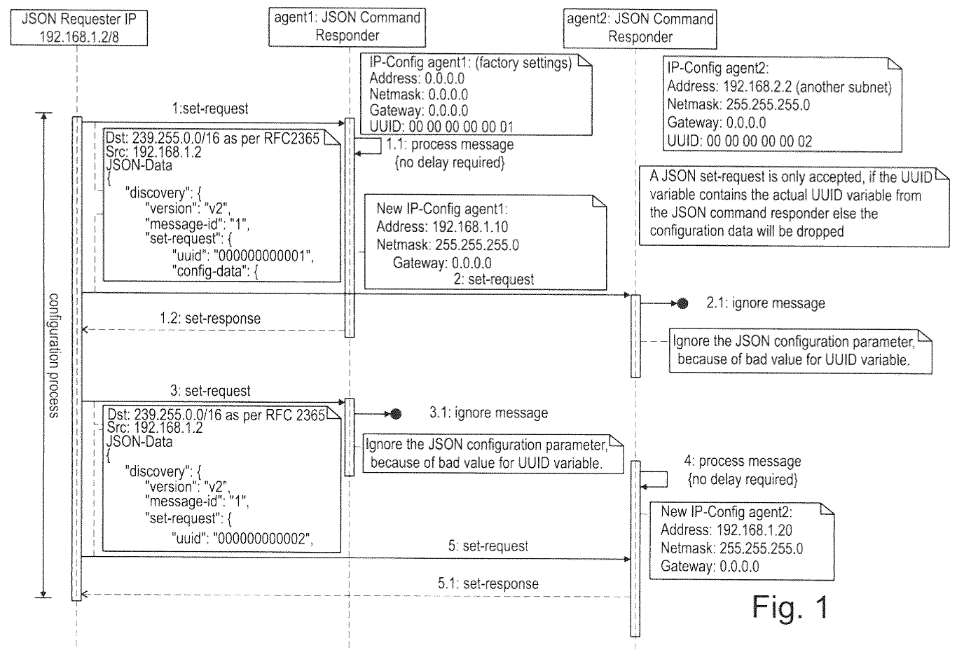

FIG. 1 shows how the network management station queries data, in particular configuration data, from a network device (agent1). The method is initiated by the network management station (JSON Requester) and is carried out in cooperation with a network device (agent1: JSON Responder) in the manner described above. The method can be carried out not only for a single network device, but also for multiple network devices. To illustrate this, FIG. 1 shows at least one further network device (agent2: JSON Responder). This means that a plurality of network devices (agentN, where N is greater than 2) can be addressed, all of which respond to the query and return data via JSON.

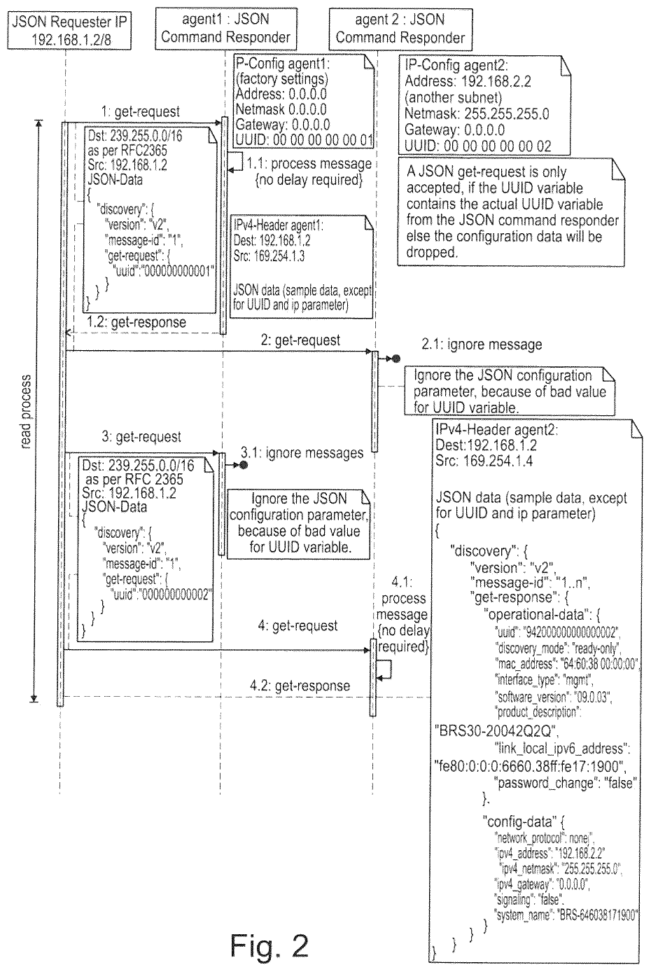

In principle, FIG. 2 shows the same procedure as shown in FIG. 1, with the difference that a UUID is sent to a selected network device (in this example, agent1) together with the query using JSON, but not to all other network devices (in this example, agent2, possibly also other network devices). As a result, only the selected network device responds to the query using JSON, while the other network devices that have also been queries ignore this query (see 2.1: Ignore message) and do not return a reply.

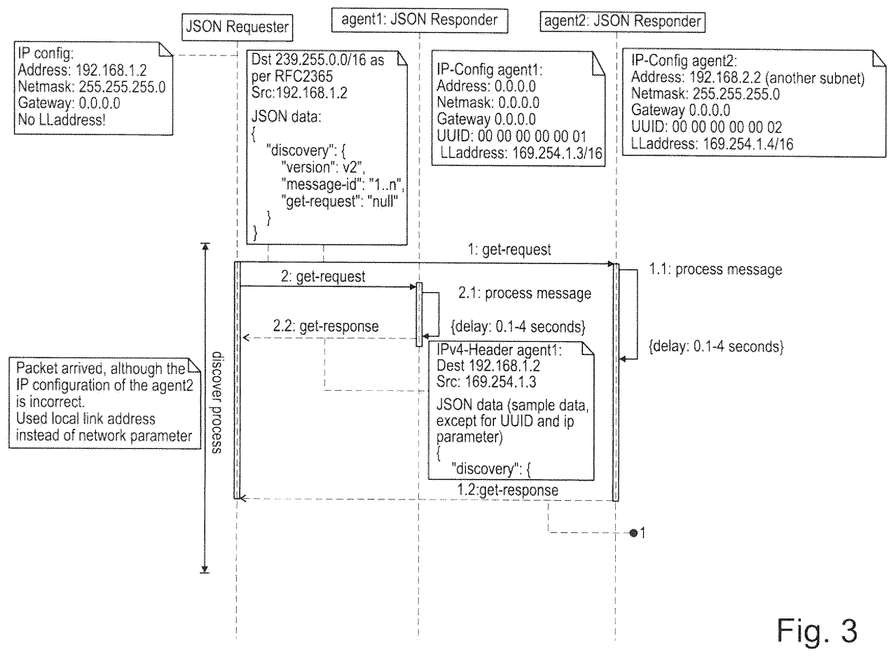

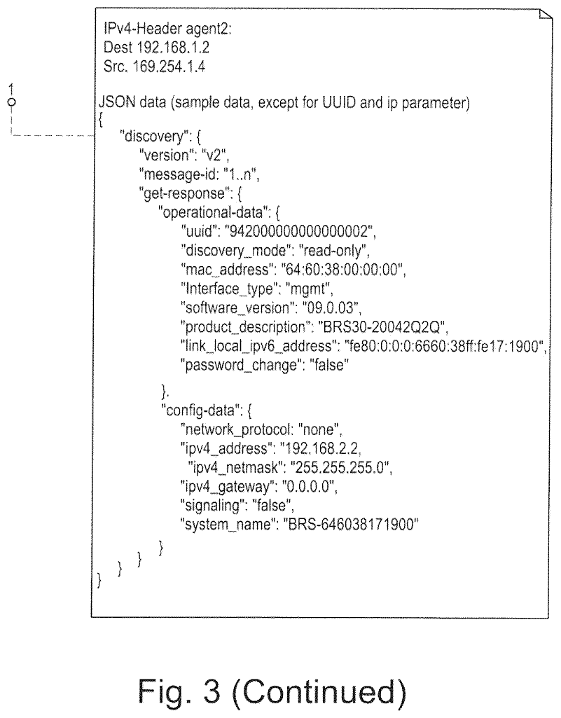

FIG. 3 shows that the method according to the invention is carried out when a network device is replaced, when an existing configuration is modified, or in similar situations. Here, too, the method is initiated by the network management station (JSON Requester IP) and is carried out in cooperation with a network device (agent1: JSON Command Responder) in the manner described above. Just like the method used for initial configuration, it is not limited to a single network device, but can be carried out on multiple network devices, in particular on all network devices in a network. By way of example, FIG. 3 again shows two network devices (agent1 and agent2). In practice, however, there will usually be more than two network devices (agent1, agent2, agentN, where N is greater than 2) in a network.

Although reference is made to the language-independent data exchange format JSON in connection with the general description of the invention and the description of an exemplary embodiment, other comparable formats may also be used as an alternative.

1. A method for operating a network, wherein at least two network devices are connected to one another via a data line and exchange data via this data line, each network device being permanently assigned a unique Media Access Control (MAC) address, and wherein a network management station controlling the configuration and/or operation of the network, wherein the network management station sends a query by multicast using a language-independent data format to the network devices in order to query the configuration parameters of the network devices and/or to configure the queried network devices using the language-independent data format.

2. The method of claim 1, wherein JavaScript Object Notation (JSON) is used as the language-independent data format.

3. The method of claim 1, wherein the respective queried network device returns its configuration parameters to the network management station via unicast by means of the language-independent data format, preferably by means of JSON.

4. The method of claim 1, wherein both the query from the network management station and the response from the queried network device are carried out at Layer 3 level.

5. The method of claim 1, wherein the actual configuration parameters of the queried network device are nevertheless returned, even if the configuration parameters sent by the network management station to the network device do not match the actual configuration parameters of the queried network device.

6. The method of claim 3, wherein if the actual configuration parameters of the network device do not match the target configuration parameters required for the intended operation of this network device, the target configuration parameters are transmitted to this network device by means of a further query from the network management station, which are then adopted by the queried network device.

7. The method of claim 4, wherein the correct adoption of the target configuration parameters by the queried network device is returned to the network management station.

8. The method of claim 1, wherein the method is carried out for non-configured and/or incorrectly configured network devices.

9. The method of claim 1, wherein the configuration parameters of the queried network device are returned independently of the IP address of this network device set at that time.

10. The method of claim 1, wherein the network device is addressed by means of a Universally Unique Identifier (UUID) within the JSON packet.
